(19) United States
(12) Patent Application Publication
(10) Pub. No.: US 2004/0225969 A1
(43) Pub. Date: Nov. 11, 2004

(54) Hand-portable electronic device with symbolic calendar application

(75) Inventors: Charles Droegemueller, Lynge (DK); Kristian Bang Jensen, Copenhagen (DK); Brian Jensen, Slangerup (DK)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/434,867

(22) Filed: May 9, 2003

(51) Int. Cl. G09G 5/00

(52) U.S. Cl. 715/804; 715/797

(57) ABSTRACT

A hand-portable electronic device comprising: a user input for receiving commands from a user; a display having at least a first portion and a second portion; a processor arranged to provide a symbolic calendar application in which an entry for an event associated with a day is visually representable by only one of a first plurality of predetermined symbols in the first portion of the display and an entry for an event associated with a time of a day is visually representable in the second portion of the display, wherein while the calendar application enables the viewing of a first day of the calendar:

a sub-period of the first day is displayed, in chronological order, in the second portion of the display; the symbol of an event associated with the first day is continuously displayed in the first portion of the display while the sub-period of the first day is varied; and a visual representation of an event associated with a first time of the first day is displayed in the second portion of the display while the first time falls within the displayed sub-period.

### FIELD OF THE INVENTION

Embodiments of the present invention relate to hand-portable electronic devices that use calendar applications.

### BACKGROUND TO THE INVENTION

Sophisticated calendar applications are available at present for personal computers. One example is Microsoft Outlook (trademark) which enables a user to enter calendar events using a keyboard. It is a textual calendar application in which a user-determined textual identifier indicates a calendar event. The textual identifier corresponds to a user-determined “subject” that has been entered via a free-text field by the user. In addition to the user-defined text identifier, the calendar application may additionally also display a standard bell icon indicating that the application will create an alarm for the event before its start time. A calendar event may be designated an “all day event”.

When the calendar application enables the viewing of, for example, a first day of the calendar, a sub-period of the first day is displayed, in chronological order, in a second portion of an application window. The displayed sub-period can be varied by the user activating the scroll bar adjacent the second portion of the application window. A textual identifier of an all-day event is continuously displayed in a first portion of the application window while the sub-period of the first day is varied and the textual identifier of an event associated with a first time of the first day is displayed in the second portion of the application window while the first time falls within the displayed sub-period.

This type of application is suitable for use with devices that have display sizes large enough to display the application window and the textual identifiers. However, the application is not suitable for hand-held electronic devices such as cellular telephones and personal digital assistants which necessarily have smaller display sizes.

### BRIEF DESCRIPTION OF THE INVENTION

It would be desirable to provide a hand-held electronic device with a more suitable calendar application.

A symbolic calendar application is defined in this patent application as a calendar application that uses a predetermined symbol (as opposed to user determined text) to identify a calendar event. The symbol used to represent a particular event can be one of a predetermined plurality of symbols, each of which represents a different type of event such as an anniversary or a reminder. An Iconographic Calendar Application is defined as a Symbolic Calendar Application that uses predetermined icons to identify a calendar event.

The term “representable” in this patent application means ‘capable of being represented’.

According to one embodiment of the invention there is provided a hand-portable electronic device comprising: a user input for receiving commands from a user; a display having at least a first portion and a second portion; a processor arranged to provide a symbolic calendar application in which an entry for an event associated with a day is visually representable by only one of a first plurality of predetermined symbols in the first portion of the display and an entry for an event associated with a time of a day is visually representable in the second portion of the display, wherein while the calendar application enables the viewing of a first day of the calendar:

a sub-period of the first day is displayed, in chronological order, in the second portion of the display;

the symbol of an event associated with the first day is continuously displayed in the first portion of the display while the displayed sub-period is varied; and

a visual representation of an event associated with a first time of the first day is displayed in the second portion of the display while the first time falls within the displayed sub-period.

The symbolic calendar application uses a much smaller amount of space than a textual calendar application, such as Microsoft Outlook.

The continuous display of the symbol of an event associated with the day being viewed in the calendar application in the first portion of the display even while the sub-period is varied, prevents the user overlooking such events which might occur if they were scrolled off the display when the sub-period is varied.

Embodiments of the invention therefore provide an improved calendar application for hand-portable electronic devices.

### BRIEF DESCRIPTION OF THE DRAWINGS

For a better understanding of the present invention reference will now be made by way of example only to the accompanying drawings in which:

FIG. 1 schematically illustrates a hand-portable electronic device; and

FIG. 2 illustrates the content of the display for a Iconographic Calendar Application.

### DETAIILED DESCRIPTION OF EMBODIMENTS OF THE INVNETION

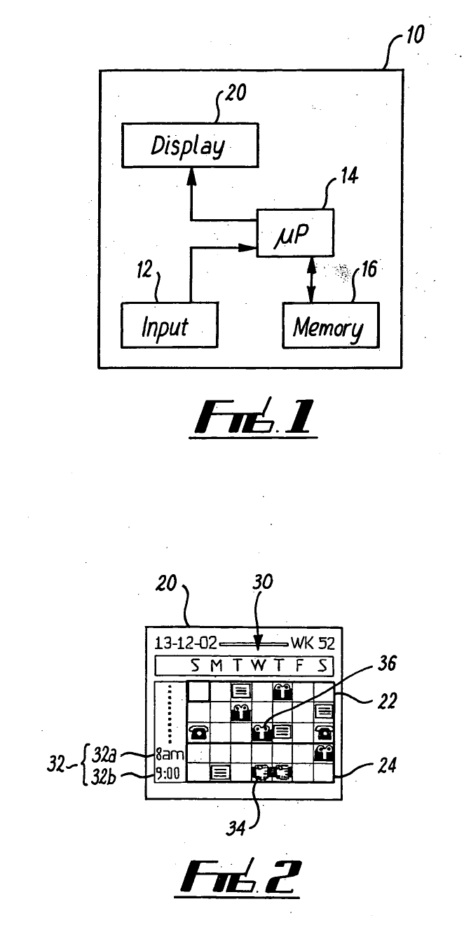

FIG. 1 schematically illustrates a hand-portable electronic device 10, such as a personal digital assistant or a cellular telephone. The hand-portable electronic device 10 comprises: a user input 12, a display 20, a processor 14 and a memory 16.

The processor 14 is connected to receive input from the user input 12, to provide output to the display 20 and to write to and read from the memory 16. The user input 12 may be any suitable device that enables a user to provide input commands to the electronic device 10. It may for example by a key-pad or it may be integrated with the display 20 as a touch-screen input sensor.

The display 20 is any suitable type of display. Typically it comprises a matrix array of pixels having a maximum dimension of no more that a few hundred pixels.

The processor 14 is controlled by program instructions loaded from storage in the memory 16. The program instructions include instructions for a Symbolic Calendar Application.

A Symbolic Calendar Application is a calendar application that uses a predetermined symbol (as opposed to user determined text) to identify a calendar event. The symbol used to represent a particular event can be one of a predetermined plurality of symbols, each of which represents a different type of event such as an anniversary or a reminder.

In the following example, an Iconographic Calendar Application will be described. This is a Symbol Calendar Application that uses an icon to identify a calendar event. The icon used to represent a particular event can be one of a predetermined plurality of icons, each of which represents a different type of event such as an anniversary or a reminder. The icon does not include user determined text.

The Iconographic Calendar Application divides the display into respective first and second contiguous portion 22, 24 as illustrated in FIG. 2. The first portion 22 and second portion 24 of the display both extend across a substantial part of the width of the display 20, with the first portion 22 positioned towards the top of the display 20 and the second portion 24 positioned towards the bottom of the display 20.

As illustrated in FIG. 2, the calendar application enables the viewing of a first day 30 of the calendar. In this example, the calendar application provides a week-view (Sunday to Saturday) in which multiple days of the calendar can be viewed simultaneously. The first day 30, for the purpose of this example, is Wednesday.

The second portion 24 of the display 20 displays a sub-period 32 of the day or days displayed. The sub-period 32 is in chronological order and is divided into separate time segments 32a, 32b. In this example the sub-period has a duration of two hours and each time segment has one hour duration, but these are exemplary and may vary from example to example.

Each calendar entry for an event associated with a time of a day is representable by a second icon in the second portion of the display. In this example, a second icon 34 representing an event associated with a first time (9 am) of the first day (Wednesday) is displayed in the second portion 24 of the display 20 adjacent the first time (9 am) when the first time falls within the sub-period 32 (9 am to 10.59 am). The second icon 34 may be any one of a plurality of predetermined icons. For example there may be a different icon for each of the following events: a meeting or a reminder.

The sub-period 32 may be varied by the processor 14. As an example, this would change the displayed sub-period 32 from 8 am, 9 am to any other two hour period such as 1 pm, 2 pm.

The processor 14 may vary the displayed sub-period 32 in response to user input commands received via the user input 12. For example, the processor may enable a user to scroll the displayed sub-period 32 within a two-hour window in the second portion 24 of the display 20.

Alternatively, or in addition, the processor 14 may maintain a real-time clock and automatically vary the displayed sub-period 32 as the real-time clock varies. The processor 14 may, for example, ensure that the current and next up-and-coming period of time is displayed in the sub-period 32 or that the sub-period containing the next up-and-coming event is displayed.

The default sub-period 32 may start at 8 am and the default start time and/or duration of the sub-period may be user programmable.

The calendar entry for an event associated with a day, as opposed to a time within a day, is represented by an icon in the first portion 22 of the display 20. A first icon 36 is continuously displayed in the first portion 22 of the display while the sub-period 32 of the first day 30 (Wednesday) is varied.

In the example of FIG. 2, three icons for events associated with the first day 30 are continuously displayable in the first portion 22 of the display 20 while the sub-period 32 is varied. The first day 30 in this example, however, only has one event (of a possible three) associated with the first day 30, an anniversary, and only one corresponding icon 36. In other examples, more or less than three icons are displayable.

In an alternative embodiment, only a sub-set of the events associated with the first day 30 may have their icons continuously displayed in the first portion of the display. The processor 14 is arranged to scroll the multiple icons within a window in the first portion 22 of the display 20 to change the continuously displayed sub-set of icons.

The user creates an entry for a calendar event by selecting a particular one of a plurality of icons to represent the event and by entering data for storage in the memory 16 in association with that event icon. There may be a different icon for each of an anniversary, a reminder, a memo, and a telephone call. The processor 14 subsequently responds to a user selecting the event icon, when displayed by the Iconographic Calendar Application, by displaying the data stored in association with that event-icon.

Although embodiments of the present invention have been described in the preceding paragraphs with reference to various examples, it should be appreciated that modifications to the examples given can be made without departing from the spirit or scope of the invention.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. A hand-portable electronic device comprising:
a user input for receiving commands from a user;
a display having at least a first portion and a second portion;
a processor arranged to provide a symbolic calendar application
in which an entry for an event associated with a day is visually representable by only one of a first plurality of predetermined symbols in the first portion of the display and an entry for an event associated with a time of a day is visually representable in the second portion of the display, wherein while the calendar application enables the viewing of a first day of the calendar:
a sub-period of the first day is displayed, in chronological order, in the second portion of the display;
the symbol of an event associated with the first day is continuously displayed in the first portion of the display while the displayed sub-period is varied; and
a visual representation of an event associated with a first time of the first day is displayed in the second portion of the display while the first time falls within the displayed sub-period.

2. A hand-portable electronic device as claimed in claim 1, wherein
multiple symbols for events associated with the first day are continuously displayed in the first portion of the display while the sub-period is varied.

3. A hand-portable electronic device as claimed in claim 1, wherein there are multiple symbols for respective multiple events associated with the first day and the processor is arranged to display continuously a sub-set of the multiple symbols in the first portion of the display while the sub-period is varied and is also arranged to vary the sub-set in response to user command.

4. A hand-portable device as claimed in claim 3, wherein the processor is arranged to scroll the multiple symbols within a window in the first portion of the display.

5. A hand-portable device as claimed in claim 1, wherein the first plurality of predetermined symbols includes a symbol representing an anniversary and a symbol representing a reminder.

6. A hand-portable electronic device as claimed in claim 1, wherein an entry for an event associated with a time of a day is visually representable by one of a second plurality of predetermined symbols in the second portion of the display, and while the calendar application enables the viewing of a first day of the calendar, a symbol of an event associated with a first time of the first day is displayed in the second portion of the display while the first time falls within the sub-period.

7. A hand-portable electronic device as claimed in claim 6, wherein a symbol of an event associated with a first time of the first day is displayed adjacent the first time.

8. A hand-portable electronic device as claimed in claim 1, wherein the processor is responsive to user input to vary the displayed sub-period of the first day.

9. A hand-portable electronic device as claimed in claim 8, wherein the processor enables a user to scroll the displayed sub-period within a window in the second portion of the display.

10. A hand-portable electronic device as claimed in claim 1, wherein the processor is responsive to a real-time clock value to vary automatically the displayed sub-period of the first day.

11. A hand-portable electronic device as claimed in claim 1, wherein the user creates an entry for an event by selecting one of a plurality of symbols and by entering data for storage in association with the symbol.

12. A hand-portable electronic device as claimed in claim 11, wherein the processor responds to a user selecting the symbol for the event by displaying the data stored in association with that symbol.

13. A hand-portable electronic device as claimed in claim 1, wherein the symbolic calendar application is an iconographic calendar application, in which the predetermined symbols are icons.

14. A hand-portable electronic device as claimed in claim 1, wherein the first portion and second portion of the display are contiguous and extend across substantially the width of the display, with the first portion positioned towards the top of the display compared to the second portion.

15. A method for providing in a hand-portable electronic device, including a display having at least a first portion and a second portion, a symbolic calendar application in which a calendar entry for an event associated with a day is visually representable by only one of a first plurality of predetermined symbols in the first portion of the display and an calendar entry for an event associated with a time of a day is visually representable in the second portion of the display, comprising the steps of:
displaying a sub-period of a first day, in chronological order, in the second portion of the display;
enabling the variation of the displayed sub-period of the first day;
continuously displaying a symbol for an event associated with the first day in the first portion of the display while the sub-period of the first day is varied; and
displaying a visual representation of an event associated with a first time of the first day in the second portion of the display while the first time falls within the currently displayed sub-period.

16. A method as claimed in claim 15, wherein the user varies the displayed sub-period of the first day.

16. A method as claimed in claim 15, wherein the displayed sub-period of the first day is varied automatically.
